(19) United States
(12) Patent Application Publication
(10) Pub. No.: US 2012/0042961 A1
(43) Pub. Date: Feb. 23, 2012

(54) METHOD AND SYSTEM FOR WATER DRAINAGE IN FUEL SYSTEM

(76) Inventors: Larry Gene ANDERSON, Erie, PA (US); Sivanaga Venu Varma Dantuluri, Hyderabad (IN); Dennis Shea, Grove City, PA (US)

(21) Appl. No.: 12/859,879

(22) Filed: Aug. 20, 2010

(51) Int. Cl. B01D 17/02

(52) U.S. Cl. 137/172

(57) ABSTRACT

Methods and systems are provided for operating a vehicle including an engine and a fuel system. In one embodiment, a water drainage system for a fuel system comprises a fuel tank, a fuel-water separator, a separator water sensor, a drain valve, a purge tank, a purge tank water sensor, and a purge port. The fuel tank is in fluid communication with the fuel-water separator which is in fluid communication with the fuel-water separator which is in fluid communication with the drain valve which is in fluid communication with the purge tank. The purge tank is enclosed within and in fluid communication with the fuel tank. The separator water sensor may be operably disposed in the fuel-water separator and the purge tank water sensor may be operably coupled to the purge tank. The purge port is in fluid communication with the purge tank.

### FIELD

Certain embodiments of the subject matter disclosed herein relate to systems and methods for an off-highway vehicle including a fuel system.

### BACKGROUND

Water may become intermixed with diesel fuel or other fuels in several ways, including purposeful mixing, condensation of humid air during transportation from refineries or other stations to end-distribution holding tanks, by leakage through faulty valves, pipes, or vents, and by careless handling. Water in fuel can cause fuel injector nozzle and pump corrosion, microorganism growth, and fuel filter plugging with materials resulting from the corrosion or microbial growth. In cold climates, ice formation in fuels containing water may cause fuel line and filter plugging degradation. Thus, various approaches are available to separate water from diesel fuel.

In one example, an off-highway vehicle, such as a locomotive or a mining truck may include a fuel-water separator for separating water from the fuel, and a purge tank for storing the separated water. The purge tank is then periodically inspected and emptied.

The inventors herein have recognized some shortcomings in such systems. For example, the required inspection interval for the purge tank may be more often than a regularly scheduled maintenance period. As such, the additional inspections for the purge tank can significantly increase maintenance costs of the vehicle. On the other hand, simply enlarging the purge tank to enable longer intervals between inspection leads to other disadvantages related to fuel system packaging, etc.

### BRIEF DESCRIPTION OF THE INVENTION

Methods and systems are provided for operating an off-highway vehicle including an engine and a fuel system. In one embodiment, a water drainage system for a fuel system comprises a fuel tank, a fuel-water separator, a drain valve, and a purge tank. The fuel-water separator is in fluid communication with the fuel tank. The drain valve is in fluid communication with the fuel-water separator. The purge tank is in fluid communication with the drain valve and the fuel tank. The purge tank may be enclosed within the fuel tank. The water drainage system for the fuel system further comprises a separator water sensor, a purge tank water sensor, and a purge port. The separator water sensor may be operably disposed in the fuel-water separator for detecting the presence of water. The purge tank water sensor may be operably coupled to the purge tank for detecting the presence of water. The purge port is in fluid communication with the purge tank for removing fluid from the purge tank. Thus, the water drainage system may operate with little or no manual intervention between scheduled maintenances of the off-highway vehicle.

This brief description is provided to introduce a selection of concepts in a simplified form that are further described herein. This brief description is not intended to identify key features or essential features of the claimed subject matter, nor is it intended to be used to limit the scope of the claimed subject matter. Furthermore, the claimed subject matter is not limited to implementations that solve any or all disadvantages noted in any part of this disclosure. Also, the inventor herein has recognized any identified issues and corresponding solutions.

### BRIEF DESCRIPTION OF THE DRAWINGS

The present invention will be better understood from reading the following description of non-limiting embodiments, with reference to the attached drawings, wherein below:

FIG. 1 shows an example embodiment of a diesel-electric locomotive including a fuel system and an engine.

FIG. 2 shows an example embodiment of a fuel system comprising a fuel tank including an exterior wall and an interior wall.

FIG. 3 shows an intersection of the interior wall with the external wall of the embodiment of the fuel tank from FIG. 2.

FIG. 4 shows an example embodiment of a method of operating an engine.

FIG. 5 shows a high level flow chart of an embodiment of a method of operating a vehicle system including an engine and a fuel system as in FIG. 2.

### DETAILED DESCRIPTION

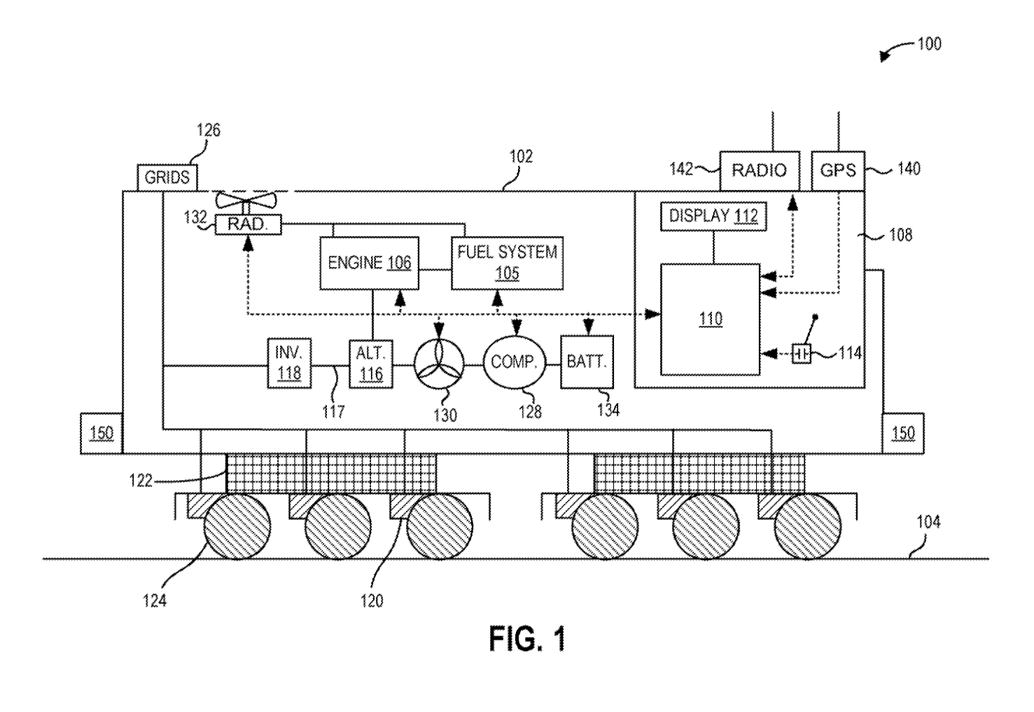

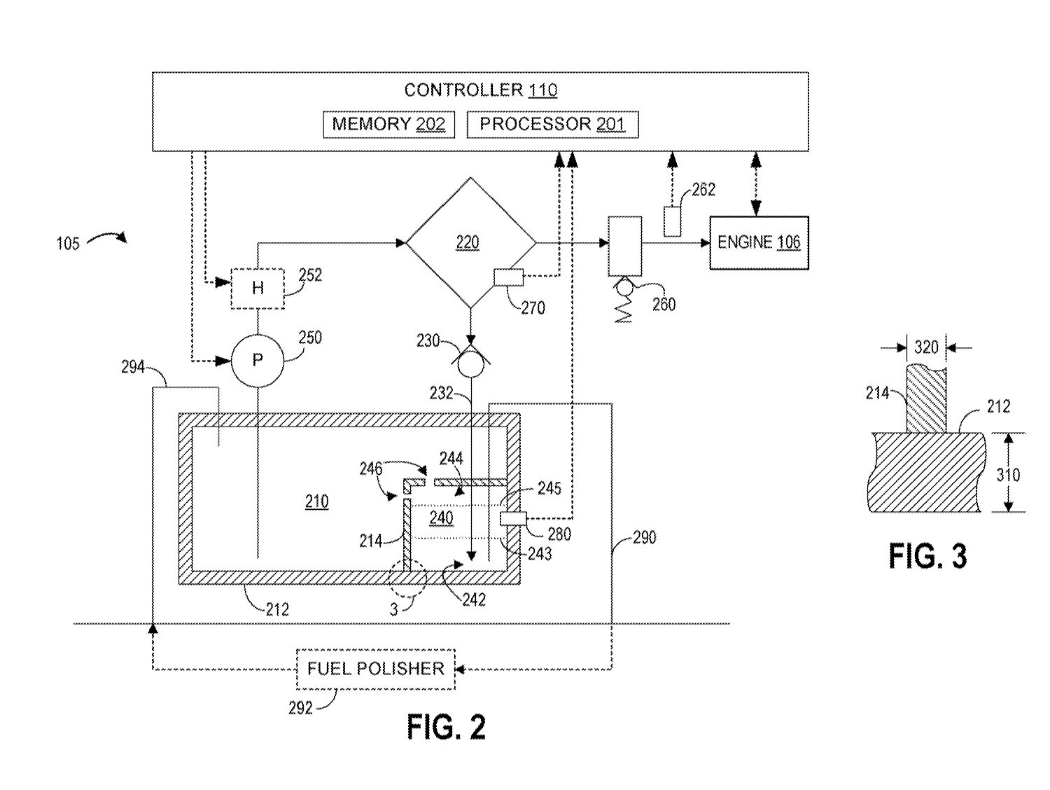

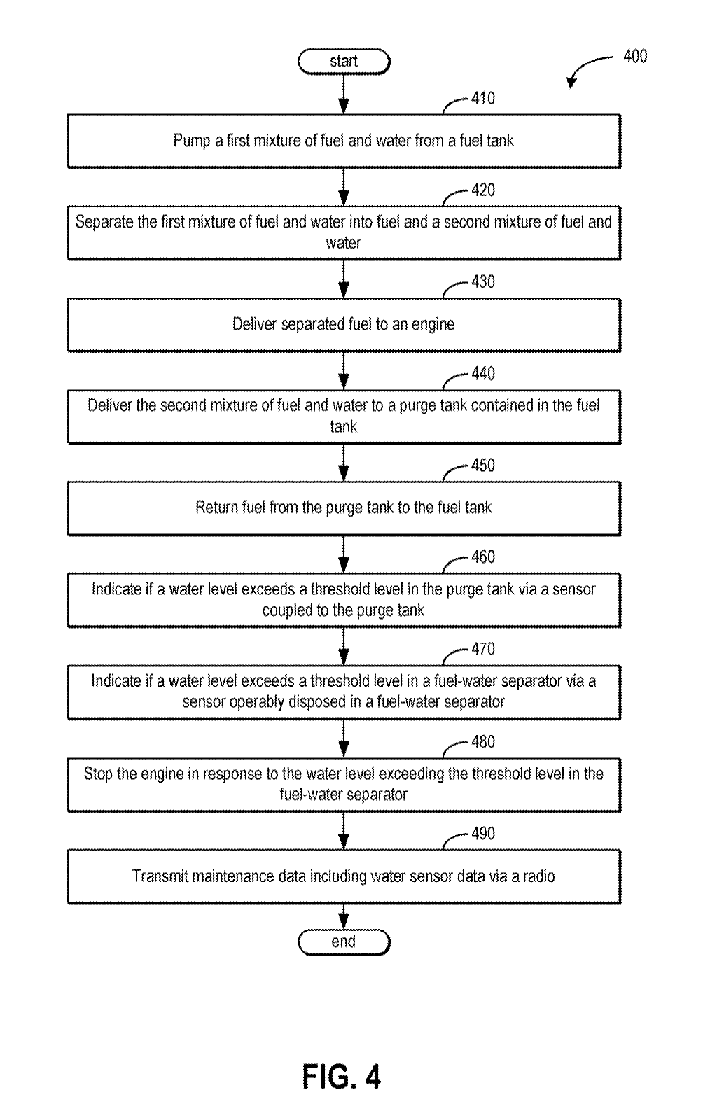

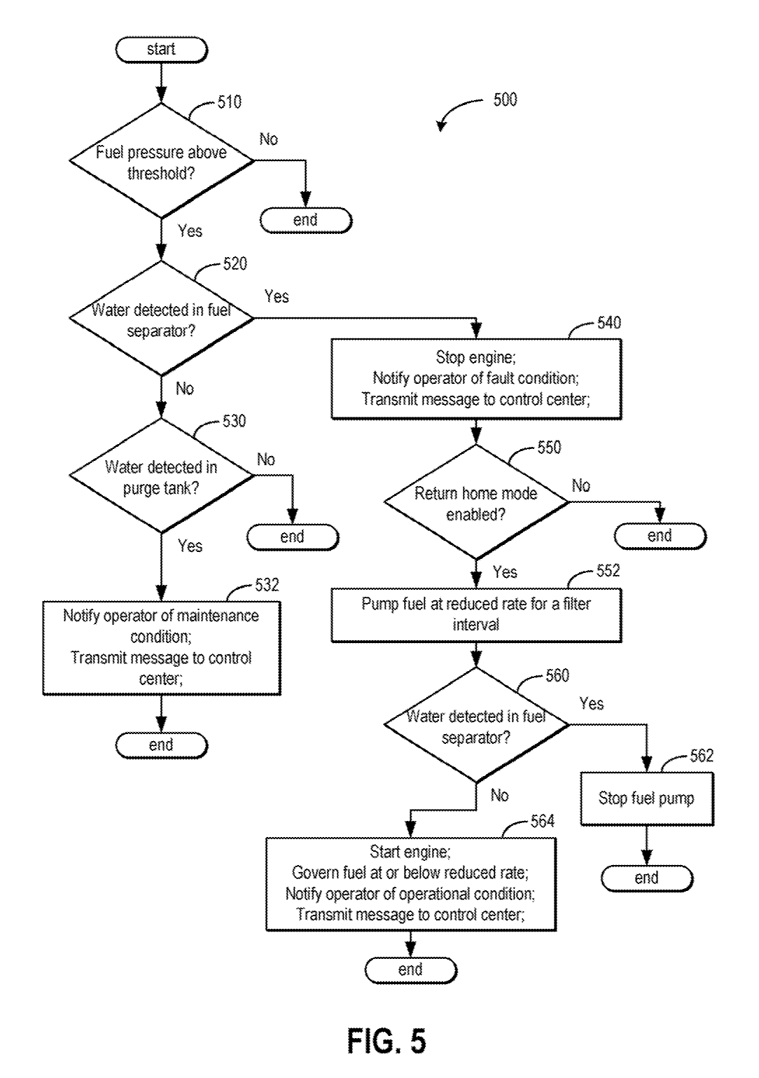

Off-highway vehicles, such as mining trucks or the example embodiment of a locomotive in FIG. 1, may include an engine supplied by a fuel system with a fuel tank. Fuel in the fuel tank may be intermixed with water and it may be desirable for the fuel system to separate the water and the fuel. An example embodiment of a fuel system, as illustrated in FIG. 2, may include a fuel tank, a fuel-water separator, and a purge tank enclosed in the fuel tank. In one embodiment, the fuel tank may include an exterior wall and an interior wall that may intersect with the exterior wall. The interior wall may be shared between the fuel tank and the purge tank. FIG. 3 shows an intersection of the interior wall with the exterior wall. FIGS. 4 and 5 show example embodiments of methods of operating a vehicle system, such as the locomotive in FIG. 1, supplied with fuel from a fuel system, such as the fuel system of FIG. 2. In this manner, water and fuel may be separated by a fuel system supplying an engine of an off-highway vehicle.

FIG. 1 is a block diagram of an example vehicle or vehicle system, herein depicted as locomotive 100, configured to run on track 104. In one example, locomotive 100 may be a diesel electric vehicle operating with a diesel engine 106 supplied with diesel fuel by a fuel system 105 located within a main engine housing 102. In other non-limiting embodiments, engine 106 may combust fuel including gasoline, kerosene, biodiesel, or other petroleum distillates of similar density. Fuel system 105, as further elaborated herein, includes a fuel-water separator for separating water out of the mixture of fuel and entrained water, or wet fuel, stored in a fuel tank. Thus, fuel with little or no water, or dry fuel, may be delivered to engine 106 and the separated water may be delivered to and stored in a purge tank of the fuel system. The fuel tank may be structurally enhanced to resist punctures and deformation. Straps and/or a protective cage may secure the fuel tank to main engine housing 102. The purge tank may be similarly structurally enhanced, or alternatively, the purge tank may be contained in the fuel tank so that the structural enhancements of the fuel tank may also benefit the purge tank.

Locomotive operating crew and electronic components involved in locomotive systems control and management, for example controller 110, may be housed within a locomotive cab 108. In one example, controller 110 may include a computer control system. The locomotive control system may further comprise computer readable storage media including code for enabling an on-board monitoring of locomotive operation. Controller 110, overseeing locomotive systems control and management, may be configured to receive signals from a variety of sensors, as further elaborated herein, in order to estimate locomotive operating parameters. For example, controller 110 may estimate geographic coordinates of locomotive 100 using signals from a Global Positioning System (GPS) radio receiver 140. Controller 110 may be further linked to display 112, such as a diagnostic interface display, providing a user interface to the locomotive operating crew. Controller 110 may control the engine 106, in response to operator input, by sending a command to various engine control hardware components such as inverters 118, alternator 116, relays, fuel injectors, fuel pumps (not shown in FIG. 1), etc. For example, the operator may select a power output for the locomotive by operating a throttle control 114.

Controller 110 and/or a locomotive operator may communicate with a control center via radio 142. As non-limiting examples, radio 142 may include a VHF radio, a cell radio, an 802.11 radio, and combinations thereof. The locomotive operator may communicate with the control center by sending and receiving voice and/or text messages via radio 142. Additionally, controller 110 may communicate with the control center by sending and receiving data messages. For example, controller 110 may transmit maintenance data and/or engine operational status to the control center via radio 142.

Engine 106 may be started with an engine starting system. In one example, a generator start may be performed wherein the electrical energy produced by a generator or alternator 116 (“ALT”) may be used to start engine 106. Alternatively, the engine starting system may comprise a motor, such as an electric starter motor, or a compressed air motor, for example. It will also be appreciated that the engine may be started using energy in a battery system, or other appropriate energy sources.

The diesel engine 106 generates a torque that is transmitted to an alternator 116 along a drive shaft (not shown). The generated torque is used by alternator 116 to generate electricity for subsequent propagation of the vehicle. The electrical power may be transmitted along an electrical bus 117 to a variety of downstream electrical components. Based on the nature of the generated electrical output, the electrical bus may be a direct current (DC) bus (as depicted) or an alternating current (AC) bus.

Alternator 116 may be connected in series to one, or more, rectifiers (not shown) that convert the alternator's electrical output to DC electrical power prior to transmission along the DC bus 117. Based on the configuration of a downstream electrical component receiving power from the DC bus, one or more inverters 118 (“INV”) may be configured to invert the electrical power from the electrical bus prior to supplying electrical power to the downstream component. In one embodiment of locomotive 100, a single inverter 118 may supply AC electrical power from a DC electrical bus to a plurality of components. In an alternate embodiment, each of a plurality of distinct inverters may supply electrical power to a distinct component.

A traction motor 120, mounted on a truck 122 below the main engine housing 102, may receive electrical power from alternator 116 through the DC bus 117 to provide traction power to propel the locomotive. As described herein, traction motor 120 may be an AC motor. Accordingly, an inverter paired with the traction motor may convert the DC input to an appropriate AC input, such as a three-phase AC input, for subsequent use by the traction motor. In alternate embodiments, traction motor 120 may be a DC motor directly employing the output of the alternator 116 after rectification and transmission along the DC bus 117. One example locomotive configuration includes one inverter/traction motor pair per wheel-axle 124. As depicted herein, six pairs of inverter/traction motors are shown for each of six pairs of wheel-axle of the locomotive. Traction motor 120 may also be configured to act as a generator providing dynamic braking to brake locomotive 100. In particular, during dynamic braking, the traction motor may provide torque in a direction that is opposite from the rolling direction, thereby generating electricity that is dissipated as heat by a grid of resistors 126 connected to the electrical bus. In one example, the grid includes stacks of resistive elements connected in series directly to the electrical bus. The stacks of resistive elements may be positioned proximate to the ceiling of main engine housing 102 in order to facilitate air cooling and heat dissipation from the grid.

Air brakes (not shown) making use of compressed air may be used by locomotive 100 as part of a vehicle braking system. The compressed air may be generated from intake air by compressor 128 (“COMP”). A multitude of motor driven airflow devices may be operated for temperature control of locomotive components. The airflow devices may include, but are not limited to, blowers, radiators, and fans. A variety of blowers 130 may be provided for the forced-air cooling of various electrical components. For example, a traction motor blower to cool traction motor 120 during periods of heavy work. Engine temperature is maintained in part by a radiator 132 (“RAD”). A cooling system comprising a water-based coolant may optionally be used in conjunction with the radiator 132 to provide additional cooling of the engine. The hot water-based coolant from the engine may also be used to heat fuel in fuel system 105.

An on-board electrical energy storage device, represented by battery 134 (“BATT”) in this example, may also be linked to DC bus 117. A DC-DC converter (not shown) may be configured between DC bus 117 and battery 134 to allow the high voltage of the DC bus (for example in the range of 1000V) to be stepped down appropriately for use by the battery (for example in the range of 12-75V). In the case of a hybrid locomotive, the on-board electrical energy storage device may be in the form of high voltage batteries, such that the placement of an intermediate DC-DC converter may not be necessitated. The battery may be charged by running engine 106. The electrical energy stored in the battery may be used during a stand-by mode of engine operation, or when the engine is shut down, to operate various electronic components such as lights, on-board monitoring systems, microprocessors, displays, climate controls, and the like. Battery 134 may also be used to provide an initial charge to start-up engine 106 from a shut-down condition. In alternate embodiments, the electrical energy storage device may be a super-capacitor, for example.

Locomotive 100 may be coupled to a vehicle, such as another locomotive or a railroad car, with a coupling device, such as coupler 150. Locomotive 100 may include one or more couplers to couple with one or more vehicles in a series of vehicles. In one example, a first locomotive may be connected to a second locomotive with coupler 150. A controller in the first locomotive, such as controller 110, may be configured to receive and transmit information to a controller in the second locomotive. The information may include the position or order of a series of locomotives, for example. As non-limiting examples, the information may be transmitted by radio 142 over a wireless network or an electrical cable connecting each locomotive. In this manner, a locomotive may communicate information such as engine and/or vehicle operating conditions to one or more other locomotives.

Returning to fuel system 105, FIG. 2 illustrates an example embodiment of fuel system 105. Fuel system 105 comprises a fuel tank 210, a fuel-water separator 220, a drain valve 230, and a purge tank 240. Fuel-water separator 220 is in fluid communication with fuel tank 210. In one embodiment, fuel entrained with water is pumped from fuel tank 210 by a pump 250 to fuel-water separator 220. An optional fuel heater 252 may be interposed between fuel tank 210 and fuel-water separator 220. In an alternate embodiment, fuel heater 252 may be coupled to fuel tank 210. In one embodiment, fuel heater 252 may transfer thermal energy from the cooling system to the fuel. For example, thermal energy from hot water-based coolant may be used to heat fuel in fuel system 105. Controller 110 may be used to control operation of pump 250 and heater 252.

Fuel-water separator 220 receives a mixture of fuel and water from fuel tank 210 and separates the mixture into dry fuel and purge liquid. The purge liquid may include fuel, water, or a water-fuel emulsion. The dry fuel may be delivered to engine 106. In one embodiment, fuel-water separator 220 is in fluid communication with a fuel pressure regulating valve 260 which is in fluid communication with engine 106. Thus, fuel may flow from an outlet port of fuel-water separator 220 through pressure regulating valve 260 to engine 106. Fuel pressure regulating valve 260 may include a check valve with a set point pressure less than or equal to a peak fuel pressure of engine 106. If the fuel pressure of fuel pressure regulating valve 260 is less than the set point pressure, fuel pressure regulating valve 260 may remain closed and all fuel from fuel-water separator 220 may be delivered to engine 106. However, if the fuel pressure of fuel pressure regulating valve 260 is greater than or equal to the set point pressure, fuel pressure regulating valve 260 may open and some fuel from fuel-water separator 220 may be diverted away from engine 106. Opening pressure regulating valve 260 may reduce the fuel pressure of fuel being delivered to engine 106 so that fuel pressure may be maintained at less than or equal to the peak fuel pressure of engine 106. In one embodiment, pressure regulating valve 260 may return fuel to fuel tank 210 when pressure regulating valve 260 is open. In one embodiment, the fuel pressure to engine 106 may be measured with a pressure sensor 262 and the pressure may be communicated to controller 110.

Fuel-water separator 220 may include a separator water sensor 270 operably disposed in fuel-water separator 220 for detecting the presence of water. Fuel-water separator 220 is a vessel, having an interior volume, which is capable of holding liquids (e.g. fuel and/or water) in a generally leak proof and watertight manner. Separator water sensor 270 may be positioned in the interior of fuel-water separator 220. Although referred to as a “water” sensor, separator water sensor 270 is more specifically a water-in-fuel sensor, that is, a sensor configured and able to detect water in the presence of fuel. Separator water sensor 270 is electrically connected to controller 110, and outputs a signal to controller 110 for indicating whether water is present at the sensor tip or other active sensor portion of separator water sensor 270 where water is detected. Separator water sensor 270 is considered as being dry if no water is detected at the sensing tip; exposure to air or liquid fuel (without water present) would be considered dry conditions.

Fuel-water separator 220 is in fluid communication with drain valve 230 which is in fluid communication with purge tank 240. Drain valve 230 may receive the purge liquid from an outlet port of fuel-water separator 220. Drain valve 230 may include a check valve with a set point pressure less than the set point pressure of the fuel pressure regulating valve. Additionally, drain valve 230 may have a set point pressure greater than a priming pressure of engine 106. In one embodiment, the set point pressure of drain valve 230 may be less than half of the set point pressure of fuel pressure regulating valve 260. In another embodiment, the set point pressure of drain valve 230 may be between ten percent and fifty percent of the set point pressure of fuel pressure regulating valve 260. When fuel pressure is less than the set point pressure of drain valve 230 (e.g. drain valve 230 is closed), the purge liquid may not flow from fuel-water separator 220 and fuel pressure may increase faster than if drain valve 230 were open. When fuel pressure is greater than or equal to the set point pressure of drain valve 230 (e.g. drain valve 230 is open), the purge liquid may flow from fuel-water separator 220 to purge tank 240.

Drain valve 230 may further include an orifice for limiting flow from fuel-water separator 220 to purge tank 240. The size of the orifice may control a maximum flow rate through the orifice and drain valve 230. For example, increasing the size of the orifice may increase flow through drain valve 230 and decrease fuel pressure. Alternatively, decreasing the size of the orifice may decrease flow through the orifice and drain valve 230 and increase fuel pressure.

Purge tank 240 is in fluid communication with drain valve 230 and fuel tank 210. In one embodiment, the purge liquid may flow from drain valve 230 through a duct 232 with an outlet near a bottom 242 of purge tank 240. For example, a lateral plane 243 may be defined as a plane cutting horizontally across purge tank 240 when purge tank 240 is positioned in its designated orientation for normal use. Near the bottom 242 of purge tank 240 may be defined as below lateral plane 243. The purge liquid is received near the bottom 242 of purge tank 240. The purge liquid may include a mixture of fuel and water which may be separated in purge tank 240. For example, water may have a greater density than fuel and so water may preferentially sink toward the bottom 242 of purge tank 240 and fuel may preferentially rise toward a top 244 of purge tank 240. In one example, near the top 244 of purge tank 240 may be defined as a lateral plane 245 cutting horizontally across purge tank 240, parallel with lateral plane 243. In one embodiment, purge tank 240 may be enclosed in fuel tank 210 and purge tank 240 may include one or more holes 246 near the top 244 of purge tank 240. Liquid may flow from purge tank 240 through one or more holes 246 into fuel tank 210. When fuel is less dense than water, the fuel may flow through the one or more holes 246 near the top 244 of purge tank 240 and water may be stored near the bottom 242 of purge tank 240. As water flows into purge tank 240 the level of the water may rise from the bottom 242 toward the top 244 of purge tank 240. An area of the one or more holes 246 may be greater than or equal to an area of the orifice of drain valve 230. In other words, the total area of all of the one or more holes 246 may be greater than or equal to an area of the orifice of drain valve 230. Thus, a maximum flow rate through the one or more holes 246 may be greater than or equal to a maximum flow rate through the orifice of drain valve 230. In an alternate embodiment, the area of each one or more holes 246 may be greater than or equal to an area of the orifice of drain valve 230.

An interior volume of purge tank 240 may be large enough for locomotive 100 to operate for an extended period without filling purge tank 240 with water. In one embodiment, the volume of purge tank 240 may be greater than or equal to the volume of water to be extracted from fuel when locomotive 100 is operated under typical or worst-case conditions between scheduled maintenance periods, such as a period of 180 days. For example, the volume of purge tank 240 may be sized according to average fuel consumption (e.g. miles per gallon) of locomotive 100, an average distance to be travelled by locomotive 100, and an average water content of fuel. In another example, the volume of purge tank 240 may be sized according to worst-case fuel consumption of locomotive 100, a worst-case distance to be travelled, and a worst-case water content of fuel. In this manner, purge tank 240 may not fill up with water between scheduled maintenance periods of locomotive 100. However, some conditions may lead to purge tank 240 filling with water before the maintenance period. For example, out of specification fuel (e.g. fuel with a water concentration in excess of the specified amount), water leaking into fuel system 105, and increased fuel consumption (e.g. burning more fuel and extracting more water) may result in purge tank 240 filling more quickly than expected.

Thus, a purge tank water sensor 280 may be operably coupled to purge tank 240 for detecting when purge tank 240 is at or near its water holding capacity. Specifically, purge tank water sensor 280 may be operably coupled to purge tank 240 for detecting the presence of water in fuel. Similar to separator water sensor 270, purge tank water sensor 280 is considered as being dry if no water is detected at the sensing tip; exposure to air or liquid fuel (without water present) would be considered dry conditions. If purge tank water sensor 280 is mounted at a pre-determined height above the bottom 242 of purge tank 240, a threshold volume of water in purge tank 240 may be determined by calculating the volume of the water column that rises to the height of purge tank water sensor 280. In one embodiment, purge tank water sensor 280 may be operably coupled to purge tank 240 above lateral plane 243. In other words, purge tank water sensor 280 may be mounted above the outlet for receiving purge liquid. In another embodiment, purge tank water sensor 280 may be operably coupled to purge tank 240 above lateral plane 243 and below lateral plane 245. In other words, purge tank water sensor 280 may be mounted above the outlet for receiving purge liquid and below the one or more holes 246 of purge tank 240. Mounting purge tank water sensor 280 nearer the top 244 of purge tank 240 may allow more water to be held in purge tank 240 than if purge tank water sensor 280 is mounted nearer the bottom 242 of purge tank 240. Thus, purge tank water sensor 280 may be mounted above a mid-point of purge tank 240. Purge tank water sensor 280 is electrically connected to controller 110 and outputs a signal to controller 110 for indicating whether water is present at the sensor tip or other active sensor portion of purge tank water sensor 280 where water is detected. In other words, purge tank water sensor 280 may indicate to controller 110 when water in purge tank 240 exceeds a threshold amount of water which may be near the water holding capacity of purge tank 240.

As further elaborated herein, the output signals from separator water sensor 270 and purge tank water sensor 280 may be processed by controller 110 for the technical effect of controlling engine 106 and fuel system 105. In one embodiment, controller 110 includes a processor 201 and a computer readable medium, such as memory 202. Instructions configured to execute on processor 201 may be encoded and stored in memory 202. For example, instructions may be configured to detect if water stored in purge tank 240 exceeds a threshold amount via purge tank water sensor 280. As another example, instructions may be configured to detect if water exceeds a threshold amount of water in fuel-water separator 220 via separator water sensor 270. Further examples of instructions that may be encoded in controller 110 are described with regard to the methods of FIGS. 4-5, which may be routines carried out by controller 110.

During maintenance, water may be removed from purge tank 240 via a purge port 290 in fluid communication with purge tank 240. In one embodiment, purge port 290 may include a suction line having an inlet near the bottom 242 of purge tank 240. In this manner, water near the bottom 242 of purge tank 240 may be removed before fuel and/or water near the top 244 of purge tank 240. Purge port 290 may be different from duct 232 to enable water to be removed from purge tank 240 without disconnecting duct 232 from drain valve 230. During maintenance, purge port 290 may be connected to an inlet of a fuel polishing cart 292 (“FUEL POLISHER”) and a fill port 294 of fuel tank 210 may be connected to an outlet of fuel polishing cart 292. Fuel polishing cart 292 may pump liquid (e.g. water and/or fuel) from purge tank 240 via purge port 290, filter (e.g. polish) the liquid, and return dry fuel to fuel tank 210 via fill port 294. In this manner, water may be removed from purge tank 240 without removing purge tank 240 from fuel tank 210. In an alternate embodiment, locomotive 100 may include fuel polishing cart 292 and liquid from purge tank 240 may be filtered when locomotive 100 is idle, for example.

Purge tank 240 may be enclosed within fuel tank 210. In one embodiment, fuel tank 210 may include one or more exterior walls, such as exterior wall 212, and one or more interior walls, such as interior wall 214. The one or more exterior walls may enclose the volume of fuel tank 210 and the one or more interior walls may form one or more compartments within fuel tank 210. For example, one compartment may form purge tank 240. In other words, purge tank 240 may share one or more walls with fuel tank 210. For example, wall 214 may be an interior wall of fuel tank 210 and a wall of purge tank 240, and wall 212 may be an exterior wall of fuel tank 210 and a wall of purge tank 240. The one or more interior walls may include one or more holes 246 extending through the one or more interior walls for fluid to flow between purge tank 240 and fuel tank 210.

FIG. 3 shows an example embodiment of an intersection of interior wall 214 with external wall 212 of fuel tank 210. Fuel tank 210 may be structurally enhanced to resist punctures and deformation. In one embodiment, external walls of fuel tank 210 may be constructed of heavy-gauge steel. Increasing the thickness of the external walls may increase the resistance to deformation and/or puncturing. However, increasing the thickness of the external walls may also increase the weight of locomotive 100 which may result in higher fuel consumption. It may also be desirable for purge tank 240 to resist deformation and punctures. Enclosing purge tank 240 within the one or more thick external walls of fuel tank 210 may protect purge tank 240 from deformation and/or punctures. Thus, internal walls of purge tank 240 (and fuel tank 210) may be thinner than external walls of fuel tank 210. In one embodiment, a thickness 310 of external wall 212 may be greater than twice as thick as a thickness 320 of internal wall 214. In an alternate embodiment, thickness 310 of external wall 212 may be greater than five times as thick as thickness 320 of internal wall 214. In yet another alternate embodiment, thickness 310 of external wall 212 may be less than five times as thick as thickness 320 of internal wall 214 and greater than twice as thick as thickness 320 of internal wall 214.

FIG. 4 shows an example embodiment of a method 400 of operating a vehicle, such as locomotive 100. At 410, a first mixture of fuel and water may be pumped from a fuel tank. For example, pump 250 may pump fuel entrained with water from fuel tank 210. In one embodiment, the fuel and water may be heated with a heater, such as heater 252. At 420, the first mixture of fuel and water may be separated into fuel and a second mixture of fuel and water. For example, fuel-water separator 220 may separate the fuel entrained with water into dry fuel and purge liquid. The purge liquid may include a second mixture of fuel and water, where the water is less emulsified in the fuel.

At 430, the separated dry fuel may be delivered to the engine. For example, dry fuel may flow from fuel-water separator 220 through fuel pressure regulating valve 260 to engine 106. Fuel pressure regulating valve 260 may limit the fuel pressure of the dry fuel to less than a peak fuel pressure of engine 106.

At 440, the second mixture of fuel and water may be delivered to a purge tank contained in the fuel tank. For example, the purge liquid may be delivered to purge tank 240 contained in fuel tank 210. In one embodiment, the purge liquid may be received in purge tank 240 via an outlet of duct 232 near the bottom 242 of purge tank 240. In one embodiment, the second mixture of fuel and water may be delivered to the purge tank if fuel pressure exceeds a priming pressure of the engine. For example, drain valve 230 may be closed when fuel pressure is less than the priming pressure of engine 106 and drain valve 230 may be open when fuel pressure is greater than or equal to the priming pressure of engine 106. In one embodiment, the priming pressure may be between ten percent and fifty percent of the peak fuel pressure.

At 450, fuel may be returned from the purge tank to the fuel tank. For example, water, having a greater density than fuel, may remain near the bottom 242 of purge tank 240 and fuel may rise to near the top 244 of purge tank 240. When purge tank 240 is full of water and fuel, and when purge liquid enters purge tank 240 through duct 232, fuel may flow through one or more holes 246 back to fuel tank 210.

At 460, a sensor coupled to the purge tank may indicate if water exceeds a threshold level in the purge tank. For example, purge tank water sensor 280 may indicate to controller 110 when water reaches the level of purge tank water sensor 280. During typical operation of locomotive 100, water may remain below the threshold level of purge tank 240. However, out-of-specification fuel having too much water, water leaks into fuel system 105, increased fuel consumption of locomotive 100, or delayed maintenance may lead to water in purge tank 240 exceeding a threshold level. During maintenance of locomotive 100, water may be removed from purge tank 240 via purge line 290, for example. Locomotive operational data and the indication from purge tank water sensor 280 may be used to diagnose potential sources of water in purge tank 240. For example, location data from GPS radio receiver 140 and data from a fuel level sensor may be used to record each filling location for locomotive 100. Excessive water content, as indicated by purge tank water sensor 280, may be correlated with the filling locations of locomotive 100 to diagnose where out-of-specification fuel may be present. As another example, water may leak from an engine component, such heater 252, into the fuel. If purge tank water sensor 280 indicates water is present earlier than expected, then additional diagnostics may be performed to identify whether one or more engine components are faulty.

At 470, a sensor operably disposed in the fuel-water separator may indicate if water exceeds a threshold level in a fuel-water separator. For example, separator water sensor 270 may indicate to controller 110 when water exceeds the threshold level in fuel-water separator 220. In one example, water may be detected if the concentration of water in fuel being pumped from fuel tank 210 exceeds the capacity of water to be separated in fuel-water separator 220. For example, the rate of water flowing into fuel-water separator 220 may exceed the rate of purge liquid flowing from fuel-water separator 220 through drain valve 230. In one example, drain valve 230, duct 232, and/or one or more holes 246 may be clogged and the flow of purge liquid may be reduced.

At 480, the engine may be stopped if water exceeds the threshold level in the fuel-water separator. For example, separator water sensor 270 may indicate to controller 110 that water exceeds the threshold level in fuel-water separator 220, and controller 110 may stop engine 106 in response thereto. Thus, engine 106 may be protected from undesirable effects of combusting fuel mixed with water. At 490, maintenance data including water sensor data may be transmitted via a radio. For example, a maintenance message may be transmitted via radio 142 in response to separator water sensor 270 indicating water exceeds the threshold level in fuel-water separator 220. As another example, a status message may be transmitted via radio 142 if purge tank water sensor 280 indicates water exceeds the threshold level in purge tank 240. In one embodiment, maintenance and/or status messages may be transmitted to a control center via a VHF or cell radio. Alternatively or additionally, maintenance and/or status messages may be transmitted to another locomotive connected to locomotive 100 by coupler 150 and linked by an 802.11 radio.

Accordingly, a vehicle system may include fuel system 105, engine 106, and controller 110. Controller 110 may be programmed to operate the vehicle system with an embodiment of a method, such as method 500, illustrated in FIG. 5. At 510, it may be determined if fuel pressure is above a threshold. For example, fuel pressure may be measured by a sensor, such as pressure sensor 262, and compared to a threshold pressure, such as the priming pressure of engine 106. If fuel pressure is less than the threshold pressure, then the method may end. Otherwise, the pressure is greater than or equal to the threshold pressure and the method may continue at 520.

At 520, it may be determined if water is detected in fuel-water separator 220. For example, separator water sensor 270 may indicate to controller 110 when water exceeds the threshold level in fuel-water separator 220. If water exceeds the threshold level, then the method may continue at 540. If water does not exceed the threshold level, then dry fuel may be delivered to engine 106 and the method may continue at 530.

At 530, it may be determined if water is detected in purge tank 240. For example, purge tank water sensor 280 may indicate to controller 110 when water exceeds the threshold level in purge tank 240. If water does not exceed the threshold level, then the purge tank is not full and the method may end. If water exceeds the threshold level, purge tank 240 may be at or near water capacity and may need to be emptied soon. The method continues at 532 if water exceeds the threshold level.

At 532, an operator of locomotive 100 may be notified of a maintenance condition. Specifically, the operator may be notified that purge tank 240 is at or near water capacity and may need to be drained. In one embodiment, controller 110 may notify the operator via a visual and/or auditory signal on display 112. Additionally, an automated message may be transmitted to a control center indicating that water in purge tank 240 exceeds the threshold level. In one example, locomotive 100 may be brought in for maintenance when water in purge tank 240 exceeds the threshold level. In another example, locomotive 100 may continue to operate if a scheduled maintenance is within a pre-determined time or mileage of locomotive 100. The method ends after 532.

At 540, water is detected in fuel-water separator 220 and water may be delivered to engine 106 if engine 106 continues to operate. Thus, engine 106 may be stopped to prevent water from being delivered to engine 106. The operator of locomotive 100 may be notified via a visual and/or auditory signal on display 112. An automated message may be transmitted via radio 142 indicating that water is detected in fuel-water separator 220. In one example, a message requesting maintenance may be transmitted to a control center via radio 142. In another example, a status message may be transmitted to another locomotive coupled to locomotive 100 via coupler 150. The method continues at 550.

At 550, it is determined if “return home” mode is enabled. For example, stopping engine 106 of locomotive 100 in a remote location may be undesirable since the operator of locomotive 100 may be stranded and maintenance may be more difficult in a remote location. Thus, a return home mode may be configured to restart engine 106 if dry fuel can be delivered to engine 106. However, locomotive 100 may be connected to one or more other locomotives via couplers 150 and it may be more desirable to stop engine 106 than to risk operating engine 106 with fuel that may be mixed with water. In one embodiment, return home mode may be disabled if locomotive 100 is connected to one or more locomotives. If return home mode is not enabled, the method may end. If return home mode is enabled, the method may continue at 552.

At 552, engine 106 is stopped and fuel may be pumped by pump 250 at a reduced rate for a pre-determined filter interval. For example, drain valve 230, duct 232, and/or one or more holes 246 may be partially clogged which may reduce the rate of flow of purge liquid from fuel-water separator 220. In another example, the concentration of water mixed with fuel from fuel tank 210 may exceed the concentration of water that may be separated by fuel-water separator 220 when fuel is pumped near a peak flow rate. Thus, pumping fuel at a reduced rate of flow may enable fuel-water separator 220 to separate the water and to deliver dry fuel to engine 106. In one example, a filter interval may be selected such that flow through fuel-water separator 220 is at a steady-state operating point. The method may continue at 560.

At 560, it may be determined if water is detected in fuel-water separator 220. For example, separator water sensor 270 may indicate to controller 110 whether water is present above a threshold amount in fuel-water separator 220. If water is detected by separator water sensor 270, then dry fuel cannot be delivered to engine 106 at the reduced flow rate and the method continues at 562. At 562, the fuel pump is stopped and then the method ends. However, if water is not detected by separator water sensor 270, then dry fuel may be delivered to engine 106 and the method may continue at 564.

At 564, engine 106 may be started and fuel delivered to engine 106 may be governed to a rate at or below the reduced rate of flow of 552. The operator of the locomotive may be notified that locomotive 100 may be operated at a reduced rate of fuel via a visual or auditory signal on display 112. An automated message may be transmitted to a control center via radio 142 indicating that locomotive 100 may be returning for maintenance. In this manner, locomotive 100 may be moved from a remote location to a shop for maintenance. The method ends after 564.

This written description uses examples to disclose the invention, including the best mode, and also to enable a person of ordinary skill in the relevant art to practice the invention, including making and using any devices or systems and performing any incorporated methods. The patentable scope of the invention is defined by the claims, and may include other examples that occur to those of ordinary skill in the art. Such other examples are intended to be within the scope of the claims if they have structural elements that do not differ from the literal language of the claims, or if they include equivalent structural elements with insubstantial differences from the literal languages of the claims. Moreover, unless specifically stated otherwise, any use of the terms first, second, etc., do not denote any order or importance, but rather the terms first, second, etc., are used to distinguish one element from another.

1. A water drainage system for a fuel system, the water drainage system comprising:
a fuel tank;
a fuel-water separator in fluid communication with the fuel tank;
a separator water sensor operably disposed in the fuel-water separator for detecting a presence of water;
a drain valve in fluid communication with the fuel-water separator;
a purge tank in fluid communication with the drain valve and the fuel tank, the purge tank enclosed within the fuel tank;
a purge tank water sensor operably coupled to the purge tank for detecting a presence of water; and
a purge port in fluid communication with the purge tank for removing fluid from the purge tank.

2. The water drainage system of claim 1, wherein the fuel tank includes an exterior wall and an interior wall, the fuel tank and the purge tank sharing at least one interior wall, the exterior wall being thicker than the interior wall.

3. The water drainage system of claim 1, wherein the drain valve is a check valve configured to enable flow from the fuel-water separator to the purge tank when fuel pressure exceeds a set point pressure of the check valve, the set point pressure greater than a priming pressure.

4. The water drainage system of claim 3, further comprising a fuel pressure regulating valve including a set point pressure less than a peak fuel pressure during engine operation, and wherein the set point pressure of the drain valve is less than half of the set point pressure of the fuel pressure regulating valve.

5. The water drainage system of claim 3, further comprising a fuel pressure regulating valve including a set point pressure less than a peak fuel pressure during engine operation, and wherein the set point pressure of the drain valve is between ten percent and fifty percent of the set point pressure of the fuel pressure regulating valve.

6. The water drainage system of claim 1, wherein the purge tank includes an outlet and one or more holes for fluid communication with the fuel tank, the outlet receiving fluid from the drain valve, the one or more holes above the outlet, the outlet distinct from the purge port.

7. The water drainage system of claim 6, wherein the purge tank water sensor is positioned below the one or more holes of the purge tank but at a height above a mid-point of the purge tank.

8. The water drainage system of claim 6, wherein the drain valve includes an orifice for limiting flow from the fuel-water separator to the purge tank, and a flow area of the orifice is less than a flow area of the one or more holes of the purge tank.

9. The water drainage system of claim 1, further comprising a radio, wherein a message is transmitted by the radio in response to the purge tank water sensor detecting the presence of water.

10. A method of operating a vehicle, the method comprising:
pumping a first mixture of fuel and water from a fuel tank;
separating the first mixture of fuel and water into separated fuel and a second mixture of fuel and water;
delivering the separated fuel to an engine of the vehicle;
delivering the second mixture of fuel and water to a purge tank contained in the fuel tank;
returning fuel from the purge tank to the fuel tank;
indicating if water exceeds a threshold level in the purge tank via a sensor coupled to the purge tank; and
transmitting a status message via a radio in response to an indication from the sensor coupled to the purge tank that a water level exceeds the threshold level in the purge tank.

11. The method of claim 10, further comprising:
indicating if a water level exceeds a threshold level in a fuel-water separator via a sensor operably disposed in the fuel-water separator;
stopping the engine in response to the water level exceeding the threshold level in the fuel-water separator; and
transmitting a maintenance message via the radio in response to the sensor operably disposed in the fuel-water separator indicating the water level exceeds the threshold level in the fuel-water separator.

12. The method of claim 10, wherein the second mixture of fuel and water are delivered to the purge tank if fuel pressure exceeds a priming pressure of the engine.

13. The method of claim 10, further comprising, limiting fuel pressure to less than a peak fuel pressure, and wherein the second mixture of fuel and water is delivered to the purge tank if fuel pressure is between ten percent and fifty percent of the peak fuel pressure.

14. A vehicle system, the vehicle system comprising:
a structurally enhanced fuel tank including an exterior wall and at least one interior wall, the exterior wall being thicker than the at least one interior wall;
a fuel-water separator in fluid communication with the structurally enhanced fuel tank;
a separator water sensor operably disposed in the fuel-water separator for detecting a presence of water;
a fuel pressure regulating valve in fluid communication with the fuel-water separator, the fuel pressure regulating valve including a set point for opening at a peak fuel pressure;
an engine in fluid communication with the fuel pressure regulating valve;
a drain valve in fluid communication with the fuel-water separator, the drain valve including a set point for opening at a pressure between ten percent and fifty percent of the peak fuel pressure;
a purge tank in fluid communication with the drain valve and the structurally enhanced fuel tank, the purge tank receiving liquid from the drain valve via an outlet near a bottom of the purge tank, the purge tank contained within the structurally enhanced fuel tank and sharing at least one interior wall of the structurally enhanced fuel tank, the purge tank including one or more holes in the shared wall for fluid communication with the structurally enhanced fuel tank;
a purge tank water sensor operably disposed in the purge tank for detecting a presence of water;
a purge port in fluid communication with the purge tank for removing fluid from the purge tank;
a controller in communication with the separator water sensor, the purge tank water sensor, and the engine; and
a computer readable medium including instructions encoded to execute on the controller, the instructions configured to:
detect if a water level exceeds a threshold level in the purge tank; and
detect if a water level exceeds a threshold level in the fuel-water separator.

15. The vehicle system of claim 14, wherein the purge tank water sensor is positioned at a height above a mid-point of the purge tank, below the one or more holes of the purge tank, and above the outlet near the bottom of the purge tank.

16. The vehicle system of claim 14, wherein the drain valve includes an orifice for limiting flow from the fuel-water separator to the purge tank, and a flow area through the orifice is less than a flow area through the one or more holes of the purge tank.

17. The vehicle system of claim 14, wherein the instructions are further configured to stop the engine in response to a water level exceeding the threshold level in the fuel-water separator.

18. The vehicle system of claim 14, further comprising a radio and wherein the instructions are further configured to transmit a message via the radio in response to detecting the water level exceeding the threshold level in the fuel-water separator.

19. The vehicle system of claim 14, further comprising a radio and wherein the instructions are further configured to transmit a message via the radio in response to detecting the water level exceeding the threshold level in the purge tank.

20. The vehicle system of claim 14, wherein the instructions are further configured to include a return home mode.
